(19) United States
(12) Patent Application Publication
(10) Pub. No.: US 2024/0070520 A1
(43) Pub. Date: Feb. 29, 2024

(54) FEDERATED AUTOMATIC MACHINE LEARNING

(71) Applicant: International Business Machines Corporation, Armonk, NY (US)

(72) Inventors: Lukasz G. Cmielowski, Krakow (PL); Daniel Jakub Ryszka, Krakow (PL); Oronde Jason Tucker, Ajax (CA); Maksymilian Erazmus, Kraków (PL)

(21) Appl. No.: 17/823,148

(22) Filed: Aug. 30, 2022

(51) Int. Cl. G06N 20/00

(52) U.S. Cl. CPC G06N 20/00

(57) ABSTRACT

Aspects of the invention include systems and methods configured for federated automatic machine learning. A non-limiting example computer-implemented method includes defining a search process including a model configuration for building an automatic machine learning pipeline definition and distributing the search process across a plurality of parties. Each member of the plurality of parties retains federated data including training data and holdout data. The method includes receiving, from each member of the plurality of parties, an evaluation result of the model configuration against respective holdout data and aggregating the received evaluation results to define aggregated parameters. A new pipeline definition is generated from the aggregated parameters and trained local models received from each member of the plurality of parties are aggregated to define an aggregated model. Each trained local model includes the new pipeline definition.

### BACKGROUND

The present invention generally relates to automatic machine learning applications, and more specifically, to computer systems, computer-implemented methods, and computer program products for federated automatic machine learning.

Recent advancements in the fields of machine learning and artificial intelligence have provided an entirely new set of tools that can be used to solve a variety of otherwise difficult or impossible problems. These tools now approach or even outperform humans and conventional computing systems in an increasingly wide range of tasks, such as, for example, in image evaluation (e.g., computer vision) and healthcare (e.g., automated diagnoses). Due to these successes, the use cases of ever more sophisticated machine learning and/or artificial intelligence-based systems and models has expanded rapidly.

One emerging field involves the development of sophisticated automatic machine learning applications and agents. At its core, automatic machine learning (sometimes referred to as automated machine learning) shifts the focus from the hyper-parameter optimization (HPO) of the best configuration of a single machine learning algorithm, to the configuration of multiple stages of a machine learning pipeline. Automatic machine learning can include several search processes, executed sequentially, that each consist of a set of iterations for finding the best values for a pipeline configuration (model configuration). Example stages during automatic machine learning can include estimator(s) selection (sometimes referred to as model selection), HPO on selected models (e.g., optimize on selected models), feature engineering (e.g., finding a best data transformation sequence), and HPO over new features (e.g., optimize on models after feature engineering), among others. In essence, automatic machine learning systems automate the often time-consuming, iterative tasks of machine learning model development. Automatic machine learning allows stakeholders, such as data scientists, analysts, and developers, to build machine learning models with high scale, efficiency, and productivity without sacrificing model quality.

### SUMMARY

Embodiments of the present invention are directed to federated automatic machine learning. A non-limiting example method includes defining a search process including a model configuration for building an automatic machine learning pipeline definition and distributing the search process across a plurality of parties. Each member of the plurality of parties retains federated data including training data and holdout data. The method includes receiving, from each member of the plurality of parties, an evaluation result of the model configuration against respective holdout data and aggregating the received evaluation results to define aggregated parameters. A new pipeline definition is generated from the aggregated parameters and trained local models received from each member of the plurality of parties are aggregated to define an aggregated model. Each trained local model includes the new pipeline definition.

Other embodiments of the present invention implement features of the above-described method in computer systems and computer program products.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of an example computing environment for use in conjunction with one or more embodiments of the present invention;

FIG. 2 depicts a block diagram of an example federated automatic machine learning system for use in conjunction with one or more embodiments of the present invention;

FIG. 3 depicts a block diagram for integrating new parties within a federated automatic machine learning system in accordance with one or more embodiments of the present invention;

FIG. 4 depicts a block diagram of an example scaled federated automatic machine learning system in accordance with one or more embodiments of the present invention; and

FIG. 5 is a flowchart in accordance with one or more embodiments of the present invention.

### DETAILED DESCRIPTION

As discussed above, automatic machine learning applications and agents shift the machine learning focus from the hyper-parameter optimization (HPO) of the best configuration of a single machine learning algorithm, to the configuration of multiple stages of a machine learning pipeline, to build machine learning models with high scale, efficiency, and productivity without sacrificing model quality. Functionally, automatic machine learning systems and agents typically train over large, preprocessed datasets, and in some implementations, can find the best (optimal) preprocessing imputation, encoding, and scaling strategies for a given application.

There are some limitations, however, in implementing automatic machine learning systems. As an initial matter, users of an automatic machine learning applications hand off their data to the automatic machine learning system and/or agent for preprocessing. For example, the dimensionality of a large dataset is typically reduced (using, e.g., principal component analysis, feature selection, etc.) so that it becomes more tractable for machine learning. These data hand-offs, usually in a raw form, introduce a range of data privacy considerations.

Federated machine learning systems represent another emerging field for machine learning and artificial intelligence. In a federated machine learning system, in contrast to an automatic machine learning system, models can be trained without sacrificing data privacy. Data privacy is ensured because each party (user) of the federated system does not have access to any other party's data. For training, partial models from each party are sent back to an aggregator service that aggregates the results (weights, gradients, etc.).

There are some constraints in implementing federated systems within the context of automatic machine learning systems. In particular, federated machine learning systems are not natively amenable to automatic learning, as fundamentally, federated machine learning systems rely upon data segregation. Moreover, automatic machine learning requires high complexity data characterizations and often long training times during the search process to find best model definitions, a process that may negatively and asymmetrically impact party resources under a federated paradigm. The reliability of search results, necessarily based on localized party results, also needs to be ensured. Finally, parties can join a federated system at any moment of a training process, whereas automatic machine learning systems represent sequential processes.

One or more embodiments of the present invention address one or more of the above-described shortcomings by providing computer-implemented methods, computing systems, and computer program products for federated automatic machine learning. Embodiments of the present invention leverage two processes: first, a search step is carried out on distributed data to find the best pipeline configuration for the federated automatic machine learning system; and second, a training step “fits” this pipeline configuration to the distributed data. Notably, the data resides solely on party sites (i.e., highly localized, protected, federated data). Integrating federated data within an automatic machine learning system in this manner provides all of the advantages of automatic machine learning without sacrificing data security.

In some embodiments, at each automatic machine learning iteration all parties (clients) get the same model configuration settings (e.g., estimator(s) type, hyper-parameters, data transformations for feature engineering, etc.) from a server (referred to as a search parameters aggregator) of the federated automatic machine learning to test. Parties evaluate these configuration settings on their local datasets, and send back their scores (machine learning scores, runtime scores, resource consumption scores, etc.) to the server. The server aggregates these scores (using, e.g., statistical measures such as taking a max, mean, average, etc. of the scores) and uses the aggregate score as a signal to continue its automatic machine learning search (i.e., the search step). At each iteration, the search sends the next configuration to the parties.

In some embodiments, after the federated automatic machine learning system finds the best pipeline model configuration (a global model configuration), the server initiates a federated learning algorithm to “fit” (using, e.g., existing federated learning algorithms) the best pipeline model configuration found in the search step. The resultant, fitted model represents a final, globally-trained federated learning model achieved using automatic machine learning.

Technical advantages and benefits of federated automatic machine learning systems configured in according with one or more embodiments include the integration of federated data (data privacy) within an automatic machine learning environment, providing all of the advantages of automatic machine learning without sacrificing data security. Systems of the present disclosure solve many of the co-integration problems with automatic learning and federated data. In particular, embodiments of the present invention introduce a search parameters aggregator(s) component that orchestrates the search process and distributes search results across the parties. One of the search parameters aggregator(s) roles is to equally distribute the search parameters and their respective values to all parties for local calculation. This ensures that each party evaluates the same set of parameters (model configurations).

In some embodiments, the search parameters aggregator(s) leverages one or more optimization enhancements to refine, quicken, or otherwise improve the distribution and calculation of the parameters. For example, the search parameters aggregator(s) can send “close”, but not identical, hyper-parameter data to each party. As used herein, “closeness” between two hyper-parameter values that can be ordered (i.e., hyper-parameters that can be placed into a list in ascending or descending order) refers to the distance between the respective hyper-parameters values, where distance is equal to how far apart the respective values are in the sorted list of all possible hyper-parameter values. In other words, closeness represents the absolute difference of hyper-parameter value indices in a sorted list. Close values can be distributed across different parties to reduce the reliability issue coming from local calculations on different data sources and also reduces evaluation time.

Another optimization enhancement is to construct a regression model (or other interpolation/extrapolation scheme) to predict (estimate) some remaining values instead of exhaustively calculating all values. For example, after calculating scores for one or more hyper-parameter values, a regression curve can be fit to the calculated scores and used to estimate scores for one or more remaining hyper-parameter values. This type of optimization can speed up the search process by reducing calculation requirements (e.g., no need to evaluate all hyper-parameters on party-side as some can be predicted). Further accelerations can be obtained by careful selection of the estimated hyper-parameters. For example, the N most difficult hyper-parameters (largest datasets, etc.) can be left to estimation. In some embodiments, the final values distribution is also updated to make sure that assigned values can be used to plot a curve (e.g., a linear regression curve) needed to compute hyper-parameter estimations. The hyper-parameter estimations can be applied to any model configuration parameters, such as, for example, estimator selection phases, reducing training time, etc.

Another one of the search parameters aggregator(s) roles is to aggregate the search results from the parties (e.g., hyper-parameter name, value, calculated score, etc.). For example, for the same parameter value(s) coming from different parties, an aggregate parameter score can be calculated using, e.g., mean values (or any other statistical measure).

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

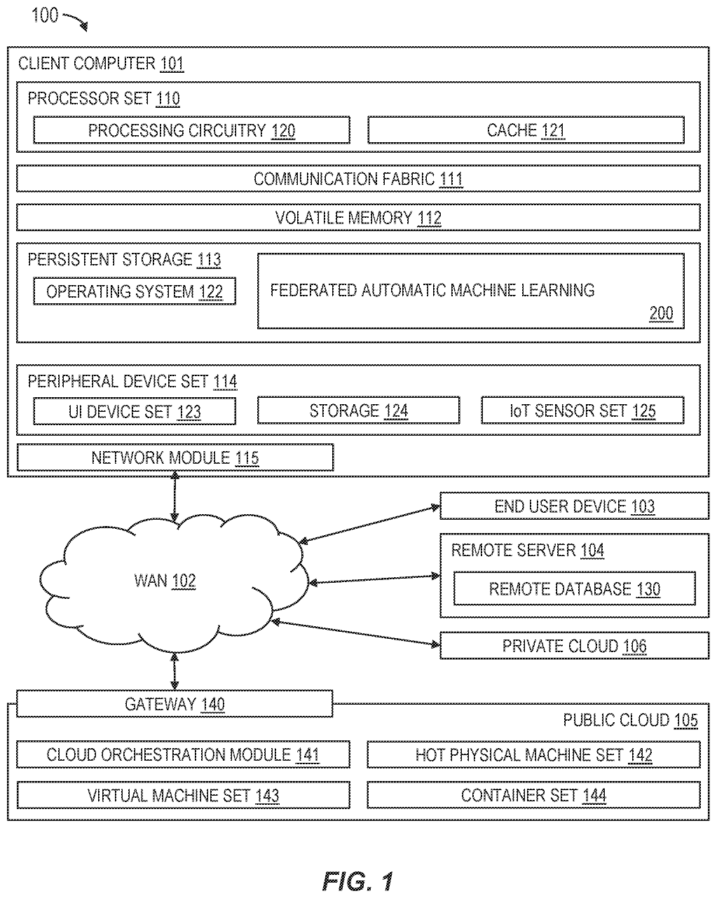

Referring now to FIG. 1, computing environment 100 contains an example of an environment for the execution of at least some of the computer code involved in performing the inventive methods, such as federated automatic machine learning 200 (referred to herein as block 200). In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the Internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

It is to be understood that the block diagram of FIG. 1 is not intended to indicate that the computing environment 100 is to include all of the components shown in FIG. 1. Rather, the computing environment 100 can include any appropriate fewer or additional components not illustrated in FIG. 1 (e.g., additional memory components, embedded controllers, modules, additional network interfaces, etc.). Further, the embodiments described herein with respect to the computing environment 100 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

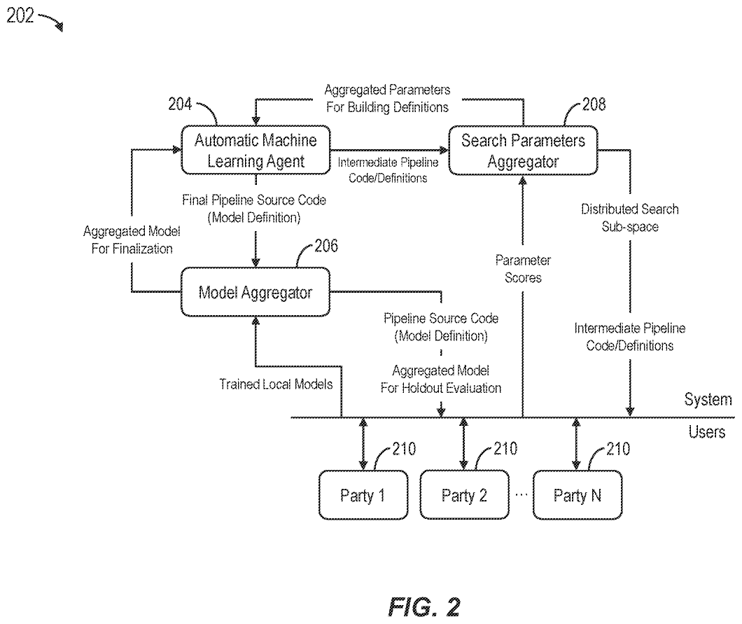

Referring now to FIG. 2, a block diagram of a federated automatic machine learning system 202 for use in conjunction with one or more embodiments of the present invention is shown. In some embodiments, the federated automatic machine learning system 202 can include or by implemented by (in whole or in part) one or more processors (e.g., the computing environment 100 of FIG. 1). In other words, any number of elements of the computing environment 100 of FIG. 1 may be used in and/or integrated into the federated automatic machine learning system 202. The federated automatic machine learning system 202 can include an automatic machine learning agent 204, a model aggregator 206, and a search parameters aggregator 208, although other components and subsystems are within the contemplated scope of the disclosure.

In some embodiments, the automatic machine learning agent 204 defines a search process (model configuration(s)) to build model definitions (i.e., a pipeline source code). The search process can be directed to any aspect of an automatic machine learning process (e.g., estimator(s) selection, hyper-parameter optimization, feature engineering, hyper-parameter optimization over new features, etc.). In some embodiments, the automatic machine learning agent 204 provides a current source code (e.g., initial or intermediate source code) and model definitions to the search parameters aggregator 208.

In some embodiments, the search parameters aggregator 208 distributes search sub-space parameters (model configurations) and intermediate model definitions (source code) across all parties 210 (e.g., Party 1, Party 2, . . . , Party N).

In some embodiments, each party of the parties 210 evaluates, using holdout data, the received model configurations/definitions (e.g., search space parameters) and returns, to the search parameters aggregator 208, a pair(s) of input search sub-space parameters and calculated values (e.g., parameter scores, such as estimator names and respective score values, hyper-parameter optimizations of a given estimator(s), etc.). Holdout data, in contrast with the training data training data that is used to train a machine learning model, is data retained to evaluate the model. Holdout data does not contribute to training, and the observations (labels) are known.

While several example parameter scores have been provided for ease of discussion, the types of parameter scores used by the federated automatic machine learning system 202 are not meant to be particularly limited. In some embodiments, one or more of the following scores can be returned by the parties 210: machine learning scores describing each evaluated model, such as accuracy, precision, recall, etc., runtime scores describing training time and evaluation time, resource scores describing available resources, such as RAM, CPU, GPU, which, for optimization, can be shared during party registration, utilization scores describing resource use, such as CPU/RAM utilization during training (discrete values, e.g., mean, max, average, peak length, etc., can be used to describe utilization scores), and/or meta-data scores describing the data set, such as a number of features, feature types, the distribution of features, the distribution of targets, etc.

In some embodiments, the search parameters aggregator 208 analyses and aggregates the responses (the parameter scores) from the parties 210. The parameter scores can be aggregated using statistical techniques such as, for example, using mean values. In some embodiments, the search parameters aggregator 208 can estimate the scores for one or more remaining values of the parameters (using, e.g., a regression model such as a linear regression) to optimize the search process as discussed previously. In other words, some parameters can be estimated rather than solved due to timing and/or resource constraints.

In some embodiments, the full search results (aggregated parameters for building definitions) are sent back to the automatic machine learning agent 204 to generate a new intermediate pipeline definition (source code). This new intermediate source code can in turn be provided to the search parameters aggregator 208 as discussed previously. In some embodiments, this process is repeated until all search spaces (all possible parameters) are explored.

Once the search space is exhausted (or, alternatively, at any intermediate point), the automatic machine learning agent 204 can send a request to train a final model(s) based on the latest configuration parameters (final pipeline source code and model definitions) to the model aggregator 206. The model aggregator 206 can provide the final pipeline source code to the parties 210.

In some embodiments, local models, trained by each respective party of the parties 210, are sent to the model aggregator 206 for aggregation. The local models can be aggregated by the model aggregator 206 using statistical techniques, such as, for example, using gradients, ensembling (an ensemble model accepts output from party models as training input/inherits information from the set of models), etc.

In some embodiments, the aggregated model(s) are sent to the parties 210 for holdout evaluation (sometimes referred to as model testing). In some embodiments, the respective evaluation/testing results are themselves aggregated by the model aggregator 206 and the aggregated model(s) and/or their respective evaluation/testing results can be sent to the automatic machine learning agent 204 for finalization (e.g., calculated metrics attachment to model metadata, status preparation, etc.).

Observe that the federated automatic machine learning system 202 navigates the holdout evaluation process without breaking data federation (i.e., while maintaining complete data privacy). In particular, the holdout is available only on party site(s). Moreover, note that each party receives the final model from the aggregator, each party receives the scorer(s) definition(s), and each party scores the model using their own holdout data (e.g., local party records). Each party sends back individual evaluation results (metric(s) values like accuracy, precision, recall, etc.) and the aggregator aggregates the scores from all parties as an evaluation score (which can be, e.g., one or a set of descriptive statistical measures such as min, max, average, etc.).

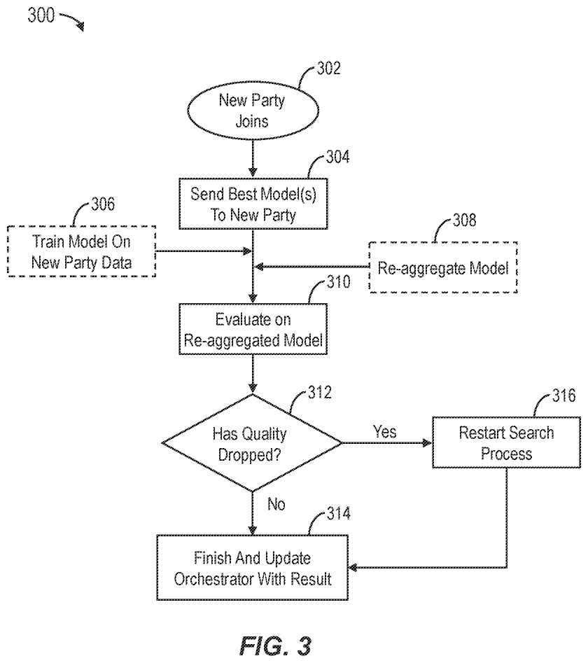

FIG. 3 illustrates a block diagram for integrating new parties within a federated automatic machine learning system in accordance with one or more embodiments. As discussed previously, the onboarding of new parties is difficult when attempting to co-integrate federated data with automatic machine learning, which is typically a sequential process. Advantageously, in some embodiments, the federated automatic machine learning system 202 (see FIG. 2) includes a training orchestrator 300 configured to solve the issues associated with onboarding new parties after a search process has been initiated. In some embodiments, the training orchestrator 300 is a separate module or agent of the federated automatic machine learning system 202. In some embodiments, the training orchestrator 300 is incorporated as functions, modules, and/or components of one or more of the automatic machine learning agent 204, the model aggregator 206, and/or the search parameters aggregator 208.

In some embodiments, the training orchestrator 300, responsive to a new party attempting to join the parties 210 (block 302), sends the current best model definitions to the new party (block 304).

At block 306, the current best model is trained, by the new party, on the new party's local data. The new party trains the model in the same manner as the other members of the parties 210 as previously described (FIG. 2).

At block 308, the model, now trained on the new party's local data, is provided to the model aggregator 206 for re-aggregation, in a similar manner as previously described with respect to the aggregation of the trained local models (FIG. 2).

At block 310, the training orchestrator 300 evaluates the re-aggregated model with the new party input. At block 312, the training orchestrator 300 determines whether, as a result of the evaluation, the model quality dropped after re-aggregation.

If model quality has not dropped (i.e., model quality remains above some predetermined threshold quality measure, such as accuracy, precision, recall, etc.), the training orchestrator 300, at block 314, finishes the new party onboarding process. Conversely, if model quality has dropped below a predetermined threshold quality measure, the training orchestrator 300, at block 316, forces a restart of the search process. In some embodiments, the training orchestrator 300 forces the federated automatic machine learning system 202 to restart the search process (e.g., finding best input parameter values) for the search space correlated with the model(s) showing a degradation in quality (e.g., accuracy, etc.). In other words, the training orchestrator 300 can initiate a retraining process for a particular model(s) for all parties.

In some embodiments, the training orchestrator 300 initiates a limited (targeted) retraining process rather than a blanket model retraining. For example, if the model experiencing quality issues is based only on hyper-parameter optimization (i.e., no feature engineering or HPO after feature engineering), only the search space for HPO needs to be re-evaluated.

Whether the training orchestrator 300 initiates a broad (total) or limited (targeted) retraining process, the final result of the retraining (i.e., the corrected model after retraining) is provided back to the training orchestrator 300 at block 314. The resultant model can be provided by one or more of the automatic machine learning agent 204, the model aggregator 206, and/or the search parameters aggregator 208.

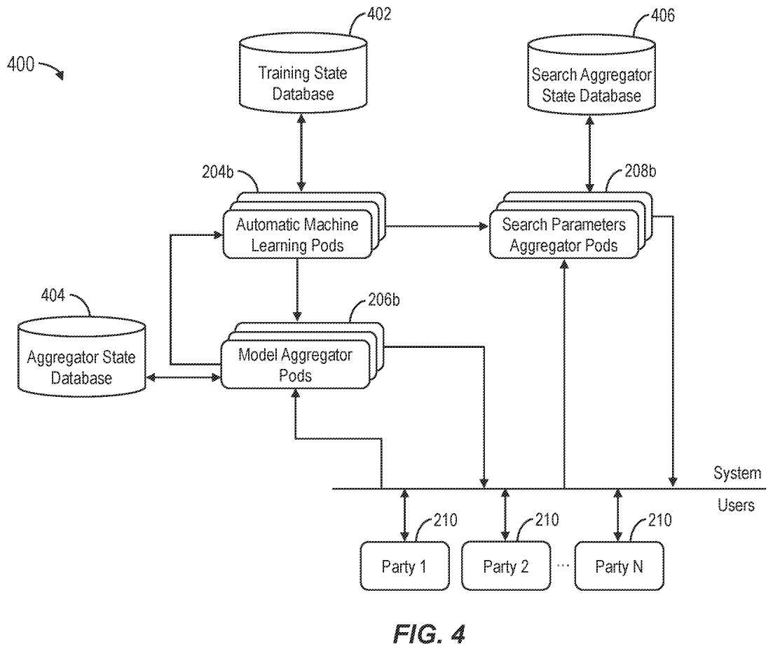

FIG. 4 illustrates a block diagram for a scaled federated automatic machine learning system 400 in accordance with one or more embodiments. In some embodiments, one or more of the automatic machine learning agent 204, the model aggregator 206, and/or the search parameters aggregator 208 (FIG. 2) can be scaled by introducing a primary node and a plurality of secondary nodes (the primary, or master node, and the secondary nodes are collectively referred to as “pods”).

As shown in FIG. 4, the automatic machine learning agent 204 can be scaled as a plurality of automatic machine learning pods 204b. Similarly, the model aggregator 206 can be scaled as a plurality of model aggregator pods 206b and the search parameters aggregator 208 can be scaled as a plurality of search parameters aggregator pods 208b. The automatic machine learning pods 204b, model aggregator pods 206b, and search parameters aggregator pods 208b can be otherwise configured in a similar manner as discussed previously with respect to the automatic machine learning agent 204, the model aggregator 206, and/or the search parameters aggregator 208.

In some embodiments, the automatic machine learning pods 204b are communicatively coupled (internally or externally) to a training state database 402. In some embodiments, the training state database 402 stores and provides the incremental (subset) outputs from each pod of the automatic machine learning pods 204b. In some embodiments, a master node (not separately shown) of the automatic machine learning pods 204b is configured to integrate the outputs from each pod of the automatic machine learning pods 204b.

In some embodiments, the model aggregator pods 206b are communicatively coupled (internally or externally) to an aggregator state database 404. In some embodiments, the aggregator state database 404 stores and provides the incremental (subset) outputs from each pod of the model aggregator pods 206b. In some embodiments, a master node (not separately shown) of the model aggregator pods 206b is configured to integrate the outputs from each pod of the model aggregator pods 206b.

In some embodiments, the search parameters aggregator pods 208b are communicatively coupled (internally or externally) to a search aggregator state database 406. In some embodiments, the search aggregator state database 406 stores and provides the incremental (subset) outputs from each pod of the search parameters aggregator pods 208b. In some embodiments, a master node (not separately shown) of the search parameters aggregator pods 208b is configured to integrate the outputs from each pod of the search parameters aggregator pods 208b.

### Illustrative Example

An end-to-end work flow for estimator selection and feature engineering is now provided for illustrative purposes. For estimator selection, the goal is to find, from the set of available estimators, the one that provides the best results when run on a full data set. Consider an scenario having three parties and an input sub-search space that includes the following variables: allocation size (having sample values [500, 1000, 1500, 2000, 2500], and estimators (support vector machine (SVM), stochastic gradient descent classifier (SGDC), logistic regression, ridge regression, extreme gradient boosting (XGB)). Consider further a hyper-parameters grid: [‘allocation size’: [500, 1000, 1500, 2000, 2500], ‘estimator’: [SVM, SGDC, logistic regression, ridge regression, XGB] and output variables including the trained model(s) and their respective score(s).

Continuing with the example, the hyper-parameters grid values are distributed across parties and models are trained on local data as described previously. For optimization purposes bigger allocation sizes (here, the 2000 and 2500 allocation sizes) are estimated by a regression model, rather than calculated, as described previously. The scores sent back by the parties are returned to, and aggregated by (including estimated values), a search parameters aggregator. The best predicted estimator(s) are used by an automatic machine learning agent to build final model(s) definitions.

Each party gets a final request to train the best selected estimator(s) on all local records (excluding holdout data) belonging to each respective party. The trained local party model(s) (characteristics, metrics, etc.) are sent to a model aggregator. The model aggregator creates a combined (ensemble, aggregated, etc.) model that takes, as an input, the weights/gradients from each trained local model(s). Finally, the aggregated model is evaluated using holdout data locally retained by each respective party (alternatively, the parties can agree to share a single, common holdout dataset for shared evaluation). After holdout evaluation, the automatic machine learning agent finalizes and returns a first group of final model(s).

Turning now to estimator selection, and continuing with the previous example, a new features search space is defined based on current dataset features and a pool of available data transformations. Transformations are not meant to be particularly limited, but can include, for example only, sums of original features, the maximum of some subset of features (or of all features), the minimum of some subset of features (or of all features), multiples or fractions of current features, etc.

New features are chosen from the search space as starting points for a tree-based search. The starting points are the beginning of branches, where each branch contains a set of the new features to apply to the dataset. These starting points are split among parties for computation (i.e., each party is allocated one or more branches). Each party calculates and evaluates the pipeline model on their respective local dataset with the provided new features set. The evaluation results are sent back to the search parameters aggregator, and eventually, to the automatic machine learning agent.

The automatic machine learning agent manages the aggregation of partial results, updates the remaining search space based on branch performance, and sends results back for additional computation. After final party results are received the best set of new features is selected for the pipelines returned in the previous stage.

The parties are then asked to re-train models on their local datasets using the recommended, final set of new features. Next, the final party models are passed to the model aggregator for aggregation. The final model evaluation and storage then takes place in a similar manner as previously described with respect to the earlier estimator(s) selection state. After this stage another set of final models is stored/returned and the federated automatic machine learning process is completed without requiring system-side access to any party data.

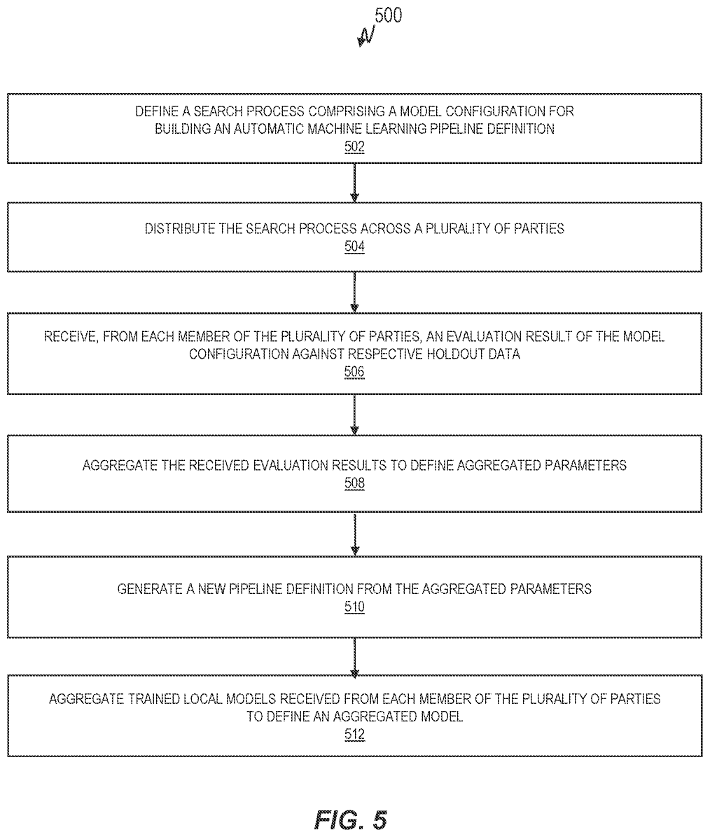

Referring now to FIG. 5, a flowchart 500 for federated automatic machine learning is generally shown according to an embodiment. The flowchart 500 is described in reference to FIGS. 1-4 and may include additional blocks not depicted in FIG. 5. Although depicted in a particular order, the blocks depicted in FIG. 5 can be rearranged, subdivided, and/or combined.

At block 502, a search process is defined by an automatic machine learning agent. The search process can include a model configuration for building an automatic machine learning pipeline definition. In some embodiments, the search process is directed to at least one of estimator selection, hyper-parameter optimization, feature engineering, and hyper-parameter optimization over new features. At block 504, the search process is distributed, by a search parameters aggregator, across a plurality of parties. Each member of the plurality of parties retains federated data including training data and holdout data.

At block 506, the search parameters aggregator receives, from each member of the plurality of parties, an evaluation result of the model configuration against their respective holdout data. In some embodiments, the evaluation result includes a search sub-space parameter and a calculated score for the search sub-space parameter. In some embodiments, the calculated score includes one or more of a machine learning score for an evaluated model, a runtime score comprising a training time and an evaluation time, a resource score describing available resources, a utilization score describing resource use, and a meta-data score describing a local data set used for model training.

At block 508, the received evaluation results are aggregated by the search parameters aggregator to define aggregated parameters. At block 510, a new pipeline definition is generated by the automatic machine learning agent from the aggregated parameters. At block 512, trained local models received from each member of the plurality of parties are aggregated by a model aggregator to define an aggregated model. Each trained local model includes the new pipeline definition.

In some embodiments, the method further includes providing, by the automatic machine learning agent, a current source code and model definition to the search parameters aggregator. In some embodiments, the method further includes estimating, by the search parameters aggregator, one or more additional scores using a regression of the calculated scores. In some embodiments, new pipeline definitions are iteratively generated until all search spaces comprising all possible parameters are explored.

In some embodiments, the aggregated model is distributed to each member of the plurality of parties for holdout evaluation. In some embodiments, the holdout evaluation results are themselves aggregated into the aggregated model (i.e., the aggregated model can be re-aggregated with the holdout evaluation results).

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

One or more of the methods described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
defining, by an automatic machine learning agent, a search process comprising a model configuration for building an automatic machine learning pipeline definition;
distributing, by a search parameters aggregator, the search process across a plurality of parties, wherein each member of the plurality of parties retains federated data comprising training data and holdout data;
receiving, by the search parameters aggregator and from each member of the plurality of parties, an evaluation result of the model configuration against respective holdout data;
aggregating, by the search parameters aggregator, the received evaluation results to define aggregated parameters;
generating, by the automatic machine learning agent, a new pipeline definition from the aggregated parameters; and
aggregating, by a model aggregator, trained local models received from each member of the plurality of parties to define an aggregated model, wherein each trained local model comprises the new pipeline definition.

2. The computer-implemented method of claim 1, wherein the search process is directed to at least one of estimator selection, hyper-parameter optimization, feature engineering, and hyper-parameter optimization over new features.

3. The computer-implemented method of claim 1, wherein the automatic machine learning agent provides a current source code and model definition to the search parameters aggregator.

4. The computer-implemented method of claim 1, wherein the evaluation result comprises a search sub-space parameter and a calculated score for the search sub-space parameter.

5. The computer-implemented method of claim 4, wherein the calculated score comprises one or more of a machine learning score for an evaluated model, a runtime score comprising a training time and an evaluation time, a resource score describing available resources, a utilization score describing resource use, and a meta-data score describing a local data set used for model training.

6. The computer-implemented method of claim 5, further comprising estimating, by the search parameters aggregator, one or more additional scores using a regression of the calculated scores.

7. The computer-implemented method of claim 1, wherein new pipeline definitions are iteratively generated until all search spaces comprising all possible parameters are explored.

8. The computer-implemented method of claim 1, wherein the aggregated model is distributed to each member of the plurality of parties for holdout evaluation.

9. The computer-implemented method of claim 8, wherein holdout evaluation results are aggregated into the aggregated model.

10. A system having a memory, computer readable instructions, and one or more processors for executing the computer readable instructions, the computer readable instructions controlling the one or more processors to perform operations comprising:
defining a search process comprising a model configuration for building an automatic machine learning pipeline definition;
distributing the search process across a plurality of parties, wherein each member of the plurality of parties retains federated data comprising training data and holdout data;
receiving, from each member of the plurality of parties, an evaluation result of the model configuration against respective holdout data;
aggregating the received evaluation results to define aggregated parameters;
generating a new pipeline definition from the aggregated parameters; and
aggregating trained local models received from each member of the plurality of parties to define an aggregated model, wherein each trained local model comprises the new pipeline definition.

11. The system of claim 10, wherein the search process is directed to at least one of estimator selection, hyper-parameter optimization, feature engineering, and hyper-parameter optimization over new features.

12. The system of claim 10, wherein the evaluation result comprises a search sub-space parameter and a calculated score for the search sub-space parameter.

13. The system of claim 12, wherein the calculated score comprises one or more of a machine learning score for an evaluated model, a runtime score comprising a training time and an evaluation time, a resource score describing available resources, a utilization score describing resource use, and a meta-data score describing a local data set used for model training.

14. The system of claim 13, further comprising estimating one or more additional scores using a regression of the calculated scores.

15. The system of claim 10, wherein new pipeline definitions are iteratively generated until all search spaces comprising all possible parameters are explored.

16. A computer program product comprising a computer readable storage medium having program instructions embodied therewith, the program instructions executable by one or more processors to cause the one or more processors to perform operations comprising:
defining a search process comprising a model configuration for building an automatic machine learning pipeline definition;
distributing the search process across a plurality of parties, wherein each member of the plurality of parties retains federated data comprising training data and holdout data;
receiving, from each member of the plurality of parties, an evaluation result of the model configuration against respective holdout data;
aggregating the received evaluation results to define aggregated parameters;
generating a new pipeline definition from the aggregated parameters; and
aggregating trained local models received from each member of the plurality of parties to define an aggregated model, wherein each trained local model comprises the new pipeline definition.

17. The computer program product of claim 16, wherein the search process is directed to at least one of estimator selection, hyper-parameter optimization, feature engineering, and hyper-parameter optimization over new features.

18. The computer program product of claim 16, wherein the evaluation result comprises a search sub-space parameter and a calculated score for the search sub-space parameter.

19. The computer program product of claim 18, wherein the calculated score comprises one or more of a machine learning score for an evaluated model, a runtime score comprising a training time and an evaluation time, a resource score describing available resources, a utilization score describing resource use, and a meta-data score describing a local data set used for model training.

20. The computer program product of claim 19, further comprising estimating one or more additional scores using a regression of the calculated scores.
